(19) United States
(12) Patent Application Publication
(10) Pub. No.: US 2007/0005368 A1
(43) Pub. Date: Jan. 4, 2007

(54) System and method of operating a speech recognition system in a vehicle

(76) Inventors: Richard J. Chutorash, Oakland Township, MI (US); Brian L. Douthitt, Holland, MI (US)

Correspondence Address: FOLEY & LARDNER LLP, 777 EAST WISCONSIN AVENUE, MILWAUKEE, WI, 53202-5306, US

(21) Appl. No.: 10/569,340

(22) PCT Filed: Jul. 28, 2004
(86) PCT No.: PCT/US04/24286

§ 371 Date: Feb. 24, 2006

Related U.S. Application Data
(60) Provisional application No. 60/498,830, filed on Aug. 29, 2003.

(51) Int. Cl. G10L 21/00

(52) U.S. Cl. 704/275

(57) ABSTRACT

A speech recognition system (10) in a vehicle includes a microphone (16), a processing circuit (12) and a wireless transceiver (14). The microphone (16) is configured to receive a spoken command from a vehicle occupant. The processing circuit (12) is configured to determine if the speech recognition system (10) has an application configured to execute the spoken command. The processing circuit (12) is also configured to generate spoken command data based on the spoken command. The wireless transceiver circuit (14) is used to transmit the spoken command data to a remote system (28) and to receive response data from the remote system (28). The processing circuit (12) performs a function based on the response data.

### BACKGROUND OF THE INVENTION

The present application relates generally to speech recognition systems in vehicles, such as automotive vehicles. One such system is a hands-free telephone system having a microphone and speakers mounted in the interior of a vehicle and a processing circuit which processes spoken commands from a vehicle occupant and performs telephone operations, such as making a telephone call. Speech recognition is used in this system to recognize a spoken command from a vehicle occupant to make a telephone call and to receive a telephone number via spoken words from the vehicle occupant. The processing circuit places the telephone call and provides an audio communication link between the vehicle occupant and the telephone system.

One drawback of prior hands-free telephone systems in vehicles was that the telephone system was not easily upgradeable because it was mounted integrally with the vehicle and was not made compatible with wireless telephones. Therefore, an improved hands-free telephone system has been developed which is configured to provide telephone services between a vehicle occupant and the occupant's own mobile telephone which is located in the vicinity of the vehicle (e.g., in a cradle, in the occupant's pocket or briefcase, etc.). In such a system, a telephone call is placed by the vehicle occupant through the hands-free telephone system mounted integral to the vehicle which creates a wireless communication link with the occupant's mobile phone. The mobile phone becomes a conduit between the hands-free telephone system and the public telephone network.

In such a hands-free telephone system, the speech recognition algorithms require a large amount of processing power and memory, and must be programmed to look for key words in the spoken command and carry out functions by invoking software applications. Because of physical size and cost restraints, processing power and memory are limited in such a vehicle-mounted module. Furthermore, if additional functions are to be added to the hands-free system, new applications to run the functions must be developed and implemented on the hands-free system. This requires additional processing power and memory, and, in the automotive application, requires that the vehicle owner return to the service dealer to receive upgrades to the software operating on the hands-free system.

Accordingly, there is a need for a system and method of operating a speech recognition system in a vehicle which can be configured with additional applications without having to develop and distribute the additional applications onto the hands-free module. Further, there is a need for a system and method of operating a speech recognition system in a vehicle that uses context processing in a more efficient manner to assist the speech recognition engine in determining how to execute a spoken command. Further, there is a need for a system and method of operating a speech recognition system in a vehicle that enables applications to be added without reprogramming the embedded hands-free module or greatly increasing its need for memory.

The teachings hereinbelow extend to those embodiments which fall within the scope of the appended claims, regardless of whether they accomplish one or more of the above-mentioned needs.

### SUMMARY OF THE INVENTION

According to one exemplary-embodiment, a method of operating a speech recognition system in a vehicle comprises receiving a spoken command from a vehicle occupant and determining if the speech recognition system has an application configured to execute the spoken command. The method further comprises, based on the determining step, sending a wireless message comprising spoken command data to a remote system, receiving response data from the remote system, and performing a function based on the response data.

According to another exemplary embodiment, a method of operating a remote speech recognition server which services a vehicle-based speech recognition system comprises, at the remote speech recognition server, receiving a wireless message comprising spoken command data from the vehicle-based speech recognition system. The method further comprises applying a speech recognition function to the spoken command data, executing the spoken command with an application, and sending a wireless response message based on the executing step to the vehicle.

According to yet another exemplary embodiment, a speech recognition system in a vehicle comprises a microphone, a processing circuit, and a wireless transceiver circuit. The microphone is configured to receive a spoken command from a vehicle occupant. The processing circuit is configured to determine if the speech recognition system has an application configured to execute the spoken command. The processing circuit is further configured to generate spoken command data based on the spoken command. The wireless transceiver circuit is configured to transmit the spoken command data to a remote system and to receive response data from the remote system. The processing circuit is configured to perform a function based on the response data.

### BRIEF DESCRIPTION OF THE DRAWINGS

The invention will become more fully understood from the following detailed description, taken in conjunction with the accompanying drawings, wherein like reference numerals refer to like parts, and in which:

FIG. 1 is a block diagram of a system for operating a speech recognition system in a vehicle, according to an exemplary embodiment;

FIG. 2 is a flowchart of a method for operating a speech recognition system in a vehicle, according to an exemplary embodiment;

FIG. 3 is a flowchart of a method of operating a remote speech recognition server which services a vehicle-based speech recognition system, according to an exemplary embodiment; and

FIG. 4 is a schematic diagram illustrating a system and method for operating a speech recognition system in a vehicle, according to an exemplary embodiment.

### DETAILED DESCRIPTION OF EXEMPLARY EMBODIMENTS

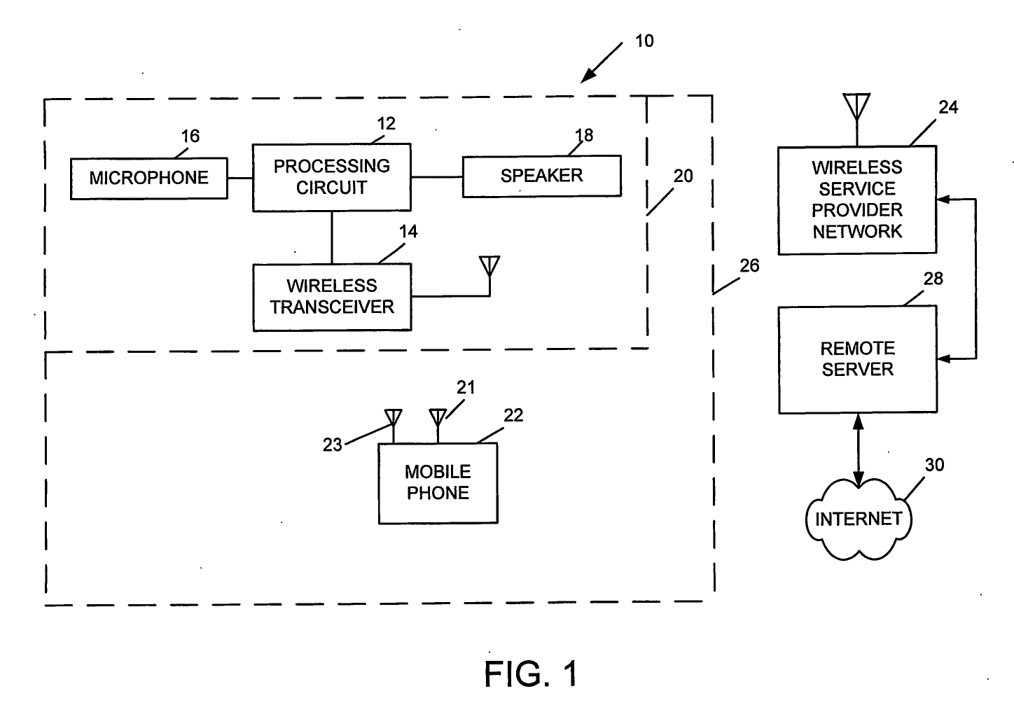

Referring to FIG. 1, a speech recognition system 10 comprises a processing circuit 12 coupled to a wireless transceiver 14, a microphone 16, and a speaker 18. Speech recognition system 10 is coupled to a vehicle interior element 20, such as an instrument panel, overhead compartment, rearview mirror, vehicle seat, or other vehicle interior element.

Processing circuit 12 can include one or more analog or digital components, such as microprocessors, microcontrollers, application specific integrated circuits (ASICs), or other processing circuitry. Processing circuit 12 can include memory, including volatile and non-volatile memory for storing a computer program or other software to perform the functions described herein. Microphone 16 can include one or more microphones configured to receive a spoken command from a vehicle occupant. The spoken command can be any word that the occupant utters or provides to system 10 to cause system 10 or another system to perform a function. Speaker 18 is configured to receive audio output data from processing circuit 12 (e.g., an audible communication from another party to a telephone call, information prompts or other messages generated by processing circuit 12, etc.). Speaker 18 can be part of the vehicle radio/tape/CD/MP3 Player, or can be a dedicated speaker serving only system 10.

Wireless transceiver 14 can be a communication circuit including analog and/or digital components configured to transmit and receive wireless data in any of a variety of data transmission formats, such as a Bluetooth communications protocol, an IEEE 802.11 communications protocol, or other personal area network protocols or other wireless communications protocols or data formats.

FIG. 1 also illustrates a mobile phone 22 which can be a cellular phone, PCS-based phone, or other mobile telephone system configured to communicate with wireless transceiver 14 and a wireless service provider network 24. Mobile phone 22 can include a plurality of transceiver circuits, for example, a Bluetooth transceiver circuit configured to communicate with wireless transceiver 14 and a cellular (e.g., CDMA, TDMA, etc.) communication format configured to communicate with wireless service provider network 24. Accordingly, in one embodiment, mobile phone 22 may include multiple antennas 21, 23. For example, antenna 21 may be used to communicate with wireless transceiver 14 (e.g., via Bluetooth, 802.11, etc.) and antenna 23 may be used to communicate with wireless service provider network 24 (e.g., via CDMA, TDMA, GSM, etc.). Alternatively, mobile phone 22 may include a single antenna. Mobile phone 22 is illustrated as being within vehicle 26 and can be located anywhere within the proximity of vehicle 26, such as, in an occupant's pocket or briefcase, in the trunk, or within a range of communication with wireless transceiver 14.

FIG. 1 further illustrates a remote server 28 which is a computer or system of computers which can be operated by a car manufacturer, the supplier of system 20, the supplier of speech recognition software operable on processing circuit 12, or another third party. Remote server 28 is coupled to the Internet 30 and configured to receive data from Internet 30 via a wired or wireless connection and to provide data through network 24 to system 10, for example via mobile phone 22.

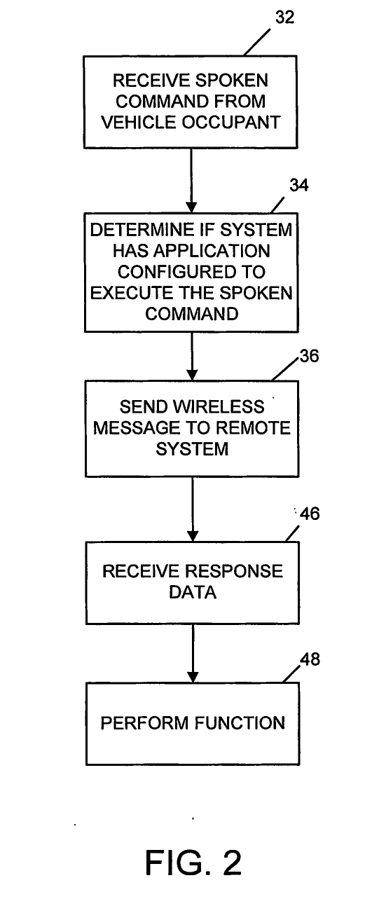

Referring now to FIG. 2, a method of operating system 10 will be described, according to an exemplary embodiment. At step 32, system 10 is configured to receive a spoken command from a vehicle occupant. For example, the spoken command may be “Call John Doe at home” or “What is the weather in Detroit?” At step 34, processing circuit is configured to determine if system 10 has an application configured to execute the spoken command. An application can be any software portion, function, or object which operates on or processes the spoken command, which operations can include speech recognition decision logic, generating prompts to provide to the occupant, comparing the command to predetermined key words or a vocabulary, requests for data from other applications, functions, or objects, etc. According to one example, a speech recognition function or engine recognizes the key word “call” and invokes or applies a hands-free dialing application which determines that the occupant uttered the name (or voice tag) “John Doe” and location “home” for which processing circuit 12 has a phone number in a prestored phone book. The hands-free dialing application can then recall the phone number from the address book in memory (or invoke a phone book application to perform this function) and initiate a dialing sequence to dial a phone call via wireless transceiver 14, mobile phone 22, and wireless service provider network 24 (FIG. 1).

In another example, system 10 will determine that it does not have an application configured to execute the spoken command. For example, the speech recognition function recognizes the word “weather” (or does not recognize any words in the spoken command). In this case, as shown at step 36, a wireless message comprising spoken command data is transmitted to a remote system, specifically remote speech recognition server 28. The spoken command data can take a variety of forms, and in one exemplary embodiment is at least a portion or all of a phoneme-based representation of the spoken command. Phonemes are phonetic units of the spoken command which can be detected by a speech recognition function. By transmitting a phoneme-based representation, which can include one or more phonemes of the spoken command, the transmission time of the spoken command data to remote server 28 can be greatly reduced as compared to transmitting a complete digitization of the spoken command. Alternatively, spoken command data can comprise the complete digitization of the spoken command, a text representation of one or more recognized words as recognized by the speech recognition function, a plurality of possible recognized words, or other data based on the spoken command.

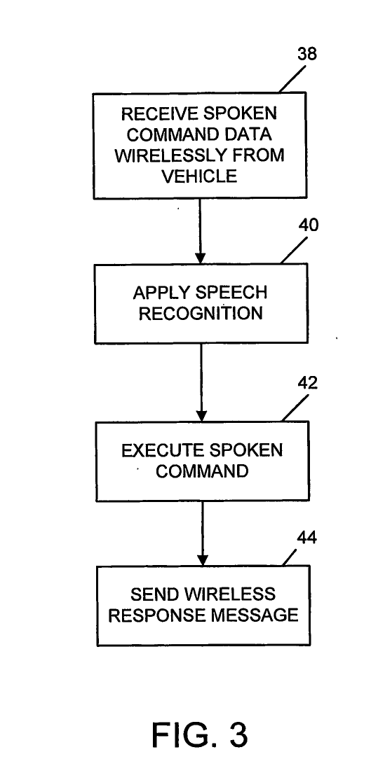

As shown in FIG. 3, remote server 28 is configured to receive the spoken command data in a wireless message from the vehicle-based system 10 at a step 38. Remote server 28 is configured to apply speech recognition software, if needed, to the spoken command data, as shown in step 40. Remote server 28 is further configured to execute the spoken command with an application stored at remote server 28 or accessed by remote server 28, as shown at step 42. Remote server 28 can execute the spoken command with an application by, for example, applying a speech recognition engine or function to recognize a key word in the spoken command and to invoke the appropriate application from a plurality of prestored applications to determine the details of the requests in the spoken command. The application can further be configured to act on the requests. For example, if the spoken command is “Get JCI stock price”, the application can be configured to access a web page at a remote server via the Internet 30, obtain the stock price for the ticker symbol JCI, and send the response via a wireless message (step 44) through mobile phone 22 to system 10.

Returning to FIG. 2, system 10 is configured to receive response data from remote server 28 at a step 46 and to perform a function at a step 48 based on the response data. The function can include providing an output to the occupant based on the response data by, for example, providing a voice response to the occupant via speaker 18 (e.g., by converting the response data in a text-to-speech converter), displaying the data in graphical or textual format, and/or performing some other function based on the response data. The voice response data could be presented to the occupant in multiple modes.

Advantageously, remote server 28 can include much greater processing and memory capabilities to run a more rigorous speech recognition algorithm on the spoken command and can further request desired information from other network-based resources, via the Internet or via other networks. Furthermore, new functions can be accessible to system 10 by storing the new applications (e.g., containing vocabulary, operator prompts, and decision logic) on one or more remote servers 28 to be accessed by system 10. Software on processing circuit 12 does not need to be substantially redesigned, if at all, or even updated.

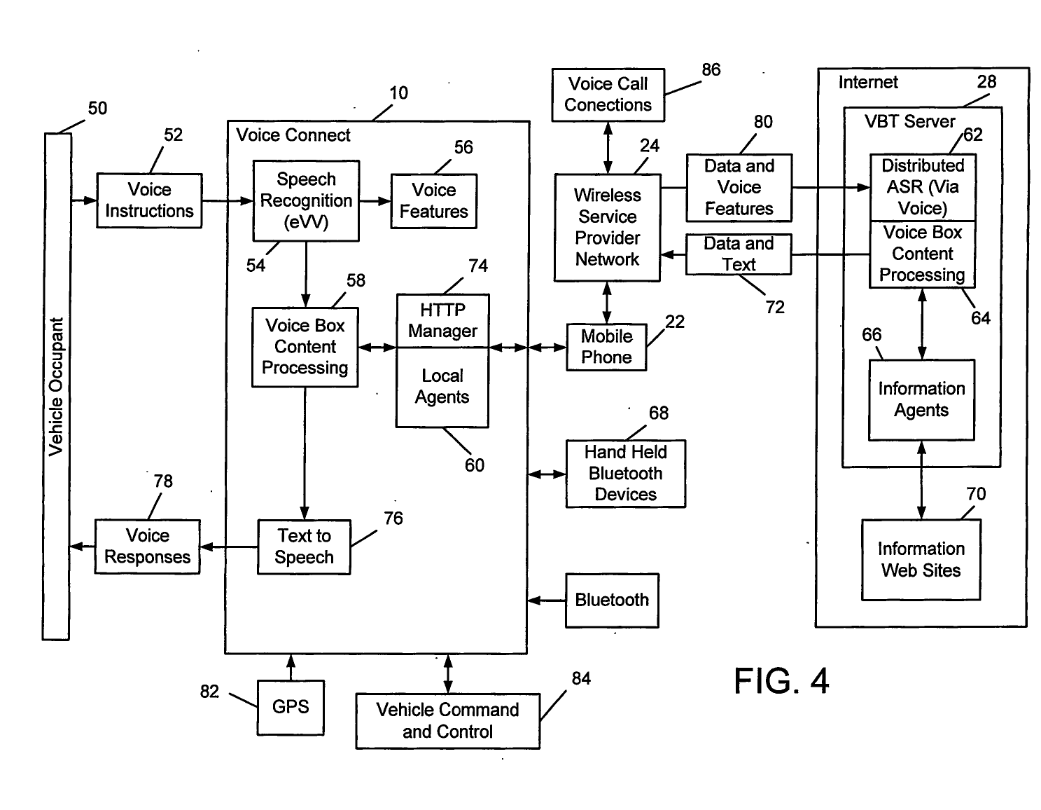

Referring now to FIG. 4, a system and method of operating a speech recognition system in a vehicle will be described according to an exemplary embodiment. A vehicle occupant 50 provides voice instructions or a spoken command 52 to system 10, shown as an embedded telematics module in this exemplary embodiment. A speech recognition function or software 54 is configured to recognize words or phrases in the spoken command. Speech recognition function 54 can comprise any speech recognition software or engine, for example, Embedded Via Voice®, manufactured by International Business Machines Corporation. Speech recognition function 54 can also be configured- to generate a phoneme-based representation of the spoken command, also called voice features 56. Speech recognition function 54 also accesses, in this exemplary embodiment, a context processing function 58, for example, a VoiceBox interactive conversation engine manufactured by VoiceBox Technologies, Inc., Kirkland, Wash., which assists speech recognition function 54 to determine the meaning of a spoken command and how to execute it. Context processing refers to a speech recognition function which uses words within a multi-word spoken command or utterance to determine the proper recognized word for other words within the multi-word spoken command. Any of a variety of context processors can be used in this exemplary embodiment. In this embodiment, speech recognition function 54 selectively invokes context processing function 58. Functions 54 and 58 are adjunct to one another, but may alternatively be one integrated software program. Speech recognition 54 and context processing 58 can further utilize an N-best recognition algorithm which identifies and ranks a plurality of recognitions for each word in a spoken command and provides those recognitions to a context processing function 58 to assist in speech recognition.

In this exemplary embodiment, speech recognition function 54 is configured to compare a recognized word to a plurality of predetermined key words to determine if system 10 has an application configured to execute the spoken command. These applications can be called local agents and are identified as local agents 60 in FIG. 4. An example of a local agent 60 might be a hands-free dialing or other telephone dialing application to execute the spoken command when the spoken command is a telephone dialing command. If system 10 determines that none of local agents 60 can be used to execute the spoken command, for example if the recognized words provided by speech recognition 54 do not match a predetermined key word or if a key word match is found for which system 10 knows it does not have a local agent (e.g., “weather” in one example), system 10 is configured to send a wireless message comprising spoken command data to or through mobile phone 22 to network 24 and to remote server 28. System 10 is configured to transmit the wireless message via wireless transceiver 14 in any of a variety of formats or protocols, such as Bluetooth, IEEE 802.11b, IEEE 802.11g or Home RF protocols. Accordingly, system 10 and mobile phone 22 each comprise suitable communications circuitry.

Mobile phone 22 can relay or forward the wireless message via network 24 to remote server 28. According to one example, a Dial-Up Networking (DUN) connection can be used, which makes the transmission of the wireless message through the phone transparent. Other protocols, such as Short Message Service (SMS) could be used. Remote server 28 can operate speech recognition and/or context processing software; for example, remote server 28 can operate the same speech recognition and context processing software as system 10, or can operate a more robust version of the software, since server 28 need not have the processing power and memory limitations of an embedded system. Thus, remote server 28 comprises speech recognition function 62 and context processing function 64. Further, various remote information agents or applications 66 can be accessed by context processing function 64 in order to execute the spoken command.

According to one exemplary embodiment, some spoken commands require off-board resources (i.e., resources not available within system 10, such as stock prices from an Internet-based server) while other spoken commands only require resources contained on-board (e.g., hands-free dialing resources, such as a hands-free dialing application, a phone book, etc.). The former are remote or distributed or off-board resources, and the latter are local or on-board resources.

Context processing functions 58 and 64 are optional. Conventional speech recognition engines are typically based on a predetermined vocabulary of words, which requires the vehicle occupant 50 to know a predetermined command structure. This may be acceptable for simpler applications, but for more complicated applications, the “natural language” understanding provided by context processing is advantageous. For example, a single natural language phrase “What is the weather in Detroit?” can replace a command structure such as: user: “weather,” hands-free system: “What city, please?” user: “Detroit.” Furthermore, natural language allows the request to be made in different forms such as “Get me the forecast for Detroit” or “Detroit weather forecast.”

Local agents or applications 60 can include a telephone dialing application, a set-up application, a configure application, a phone book application, and/or other applications. For example, the set-up application can be configured to provide a Bluetooth pairing function with a Bluetooth-enabled device 68, such as a personal digital system, mobile phone, etc. The configure application can be configured to allow the occupant to establish preferences for the behavior (user profile) of system 10 or other modules/functions in the vehicle. The phone book application can be configured to create, edit, and delete phone book entries in response to spoken commands and to provide operator prompts via voice responses 78 through speaker 18 to guide occupant 50 through phone book functions.

Remote server 28 is configured to determine if the spoken command request data is available from a website 70 stored on a server accessible via the Internet. Remote server 28 is configured to receive data from website 70 and provide the data in a wireless response message 72. Wireless response message 72 can include data, text, and/or other information provided via network 24 and phone 22 to system 10. Optionally, a hypertext transfer protocol (HTTP) manager 74 operable on system 10 (and/or on remote server 28) can be provided to facilitate transmission and receipt of messages in a hypertext or other markup language. Alternatively, other data formats can be used. System 10 then is configured to perform a function based on the wireless response message. In one example, a text-to-speech converter 76 converts response data to speech and provides a voice response 78 to vehicle occupant 50, for example, “JCI stock price is 100”. As shown at element 80 and described hereinabove spoken command data 80 provided to remote server 28 can take any of a variety of forms, such as phonemetric data or other data.

The functions that can be performed by system 10 are not limited to telephone dialing and acquiring data from Internet web pages. According to another example, a location determining system 82 (e.g., a global positioning system, dead reckoning system, or other such system) is configured to provide vehicle location information to system 10). System 10 can be configured to retrieve navigation information from remote server 28 and use information from GPS 82 to provide navigation data to vehicle occupant 50. According to another exemplary embodiment, the vehicle occupant 50 can provide vehicle command and control functions via a vehicle bus 84 which is coupled to system 10. For example, system 10 can be configured to receive a spoken command to control HVAC options, radio selections, vehicle seat position, interior lighting, etc. According to another example, a music management function can be provided by coupling a hand-held Bluetooth-enabled music source 68 (e.g., an MP3 player, laptop personal computer with a built-in or add-on Bluetooth transceiver, or a headset controlled by spoken commands via system 10. According to another example, system 10 can provide vehicle location and heading and/or traffic information. According to another example, communication functions can be provided by system 10, such as hands-free telephone calling, voice memo e-mail sending and receiving e-mail notification, wherein the e-mails can be converted text-to-speech and provided via voice responses 78. According to another example, calendar/to-do list functions can be provided; for example, a to-do list can be converted text-to-speech from a hand-held Bluetooth device 68, such as a personal digital assistant, laptop computer, etc. According to another example, personalized news functions can be provided in response to a spoken command request either from a predetermined Internet service provider source, such as www.yahoo.com or from user selectable sources via spoken commands. Other functions are contemplated.

As illustrated at voice call connection 86, mobile phone 22 and network 24 are configured to provide hands-free phone operation with system 10 for a voice phone call between a third party and vehicle occupant 50.

While the exemplary embodiments illustrated in the FIGS. and described above are presently preferred, it should be understood that these embodiments are offered by way of example only. For example, the teachings herein can be applied to any speech recognition system in a vehicle and is not limited to hands-free telephone applications. Accordingly, the present invention is not limited to a particular embodiment, but extends to various modifications that nevertheless fall within the scope of the appended claims.

1. A method of operating a speech recognition system in a vehicle, comprising:
receiving a spoken command from a vehicle occupant;
determining if the speech recognition system has an application configured to execute the spoken command;
based on the determining step, sending a wireless message comprising spoken command data to a remote system through a mobile telephone in the proximity of the vehicle;
receiving response data from the remote system; and
performing a function based on the response data.

2. A method according to claim 1, further comprising: based on the determining step, applying a telephone dialing application to execute the spoken command when the spoken command is a telephone dialing command.

3. A method according to claim 1, wherein the step of sending comprises sending the wireless message to a remote speech recognition server.

4. A method according to claim 1, wherein the step of sending comprises sending the wireless message in a Bluetooth communications protocol.

5. A method according to claim 1, wherein the determining step comprises:
applying a speech recognition function to the spoken command to generate a recognized word; and
comparing the recognized word to a plurality of predetermined keywords to determine if the speech recognition system has an application configured to execute the spoken command.

6. A method according to claim 5, wherein, if the recognized word does not match a predetermined keyword, sending the wireless message comprising spoken command data to the remote system.

7. A method according to claim 1, further comprising generating a phoneme-based representation of the spoken command, wherein the wireless message includes at least a portion of the phoneme-based representation.

8. A method according to claim 1, wherein the function is providing an output to the occupant based on the response data.

9. A method according to claim 8, further comprising converting response data text to speech to provide a voice response to the occupant.

10. A method of operating a remote speech recognition server which services a vehicle-based speech recognition system, comprising, at the remote speech recognition server:
receiving a wireless message comprising spoken command data received from a mobile telephony unit, wherein the mobile telephony unit is linked via a wireless connection to the vehicle-based speech recognition system;
applying a speech recognition function to the spoken command data;
executing the spoken command with an application; and
sending a wireless response message based on the executing step to the vehicle.

11. A method according to claim 10, further comprising:
determining that the spoken command requests data available from a remote server accessible via the Internet;
requesting data from the remote server;
providing the data in the wireless response message.

12. A method according to claim 10, further comprising applying a context processor application to the spoken command to execute the spoken command.

13. A method according to claim 10, further comprising determining which of a plurality of server-based applications to use in executing the spoken command.

14. A speech recognition system in a vehicle, comprising:
a microphone configured to receive a spoken command from a vehicle occupant;
a processing circuit configured to determine if the speech recognition system has an application configured to execute the spoken command and to generate spoken command data based on the spoken command; and
a wireless transceiver circuit having a wireless link to a mobile telephony unit, wherein the wireless transceiver circuit is configured to transmit the spoken command data to a remote system and to receive response data from the remote system, wherein the processing circuit is configured to perform a function based on the response data.

15. A speech recognition system according to claim 14, wherein the processing circuit is further configured to apply a telephone dialing application to execute the spoken command when the spoken command is a telephone dialing command.

16. A speech recognition system according to claim 14, wherein determining if the speech recognition system has an application configured to execute the spoken command includes applying a speech recognition function to the spoken command to generate a recognized word and comparing the recognized word to a plurality of predetermined keywords to determine if the speech recognition system has an application configured to execute the spoken command.

17. A speech recognition system according to claim 16, wherein, if the recognized word does not match a predetermined keyword, the wireless transceiver transmits the spoken command data to the remote system.

18. A speech recognition system according to claim 14, wherein the function is providing an output to the occupant based on the response data.

19. A speech recognition system according to claim 18, wherein the processing circuit is further configured to convert the response data text to speech to provide a voice response to the occupant.
